(19) United States
(12) Patent Application Publication
(10) Pub. No.: US 2026/0036892 A1
(43) Pub. Date: Feb. 5, 2026

(54) LIGHT SOURCE APPARATUS AND PROJECTOR

(71) Applicant: SEIKO EPSON CORPORATION, Tokyo (JP)

(72) Inventors: Wataru YASUMATSU, AZUMINO-SHI (JP); Namiko ONOTA, MATSUMOTO-SHI (JP)

(21) Appl. No.: 19/286,397

(22) Filed: Jul. 31, 2025

(30) Foreign Application Priority Data
Aug. 2, 2024 (JP) 2024-127668

(51) Int. Cl. G03B 21/20

(52) U.S. Cl. CPC G03B 21/204; G03B 21/2053; G03B 21/2066; G03B 21/208

(57) ABSTRACT

A light source apparatus according to the present disclosure includes: a light source configured to output first light; a diffuser that the first light output; an optical element that the first light passing through the diffuser enters; a light collection system that the first light passing through the optical element enters; a wavelength converter configured to convert part of the first light into second light; and a reflection system configured to reflect another part of the first light, wherein the optical element includes a first reflection film configured to reflect the second light, the wavelength converter includes a light incident surface on which the first light is incident, and a second reflection film provided at the light incident surface and configured to separate the first light into the part and the other part, and the other part of the first light separated by the second reflection film enters the diffuser.

The present application is based on, and claims priority from JP Application Serial Number 2024-127668, filed Aug. 2, 2024, the disclosure of which is hereby incorporated by reference herein in its entirety.

### BACKGROUND

### 1. Technical Field

The present disclosure relates to a light source apparatus and a projector.

### 2. Related Art

In related art, there is a proposed light source apparatus that separates blue light output from a light source into two parts, causes one of the parts, into which the blue light is separated, to enter a phosphor to generate yellow fluorescence, and diffuses the other part of the separated parts, into which the blue light is separated, combines the diffused blue light with the yellow fluorescence to produce white light, and outputs the white light (see JP-A-2018-013764, for example).

JP-A-2018-013764 is an example of the related art.

In the light source apparatus described above, however, since the optical path of the part of the blue light traveling toward the phosphor and the optical path of the other part of the blue light traveling toward the diffuser plate differ from each other, it is necessary to dispose optical parts in the optical paths, so that there is a problem of an increase in size of the apparatus configuration.

### SUMMARY

According to a first aspect of the present disclosure, there is provided a light source apparatus including: a light source configured to output first light having a first wavelength band; a diffuser that the first light output from the light source enters; an optical element that the first light passing through the diffuser enters; a light collection system that the first light passing through the optical element enters; a wavelength converter configured to convert part of the first light into second light having a second wavelength band different from the first wavelength band; and a reflection system configured to reflect another part of the first light output from the wavelength converter, wherein the optical element includes a first reflection film configured to transmit the first light and reflect the second light, the wavelength converter includes a wavelength conversion layer having a first surface on which the first light is incident, and a second reflection film provided at the first surface and configured to separate the first light into the part and the other part, and the other part of the first light separated by the second reflection film enters the diffuser.

According to a second aspect of the present disclosure, there is provided a light source apparatus including: a light source configured to output first light having a first wavelength band; a diffuser configured to transmit the first light output from the light source; a reflection system configured to reflect the first light passing through the diffuser; an optical element that the first light reflected by the reflection system enters; a light collection system that the first light passing through the optical element enters; and a wavelength converter configured to convert part of the first light into second light having a second wavelength band different from the first wavelength band, wherein the optical element includes a first reflection film configured to transmit the first light and reflect the second light, the wavelength converter includes a wavelength conversion layer having a first surface on which the first light is incident, and a second reflection film provided at the first surface and configured to separate the first light into the part and another part, and the other part of the first light separated by the second reflection film enters the diffuser.

According to a third aspect of the present disclosure, there is provided a projector including the light source according to the first aspect or the second aspect; a light modulator configured to modulate light incident from the light source apparatus in accordance with image information; and a projection optical apparatus configured to project the light modulated by the light modulator.

### BRIEF DESCRIPTION OF THE DRAWINGS

FIG. 1 is a schematic view showing the configuration of a projector according to a first embodiment.

FIG. 2 is a schematic view showing the configuration of a light source apparatus according to the first embodiment.

FIG. 3 is a schematic view showing the configuration of a light source apparatus according to a first modification.

FIG. 4 is a schematic view showing the configuration of a light source apparatus according to a second modification.

FIG. 5 is a schematic view showing the configuration of a light source apparatus according to a second embodiment.

FIG. 6 is a schematic view showing the configuration of a light source apparatus according to a third modification.

### DESCRIPTION OF EMBODIMENTS

Embodiments of the present disclosure will be described below with reference to the drawings. In the drawings, elements are drawn at dimensional scales changed from the actual ones in some cases for clarity of each of the elements.

### First Embodiment

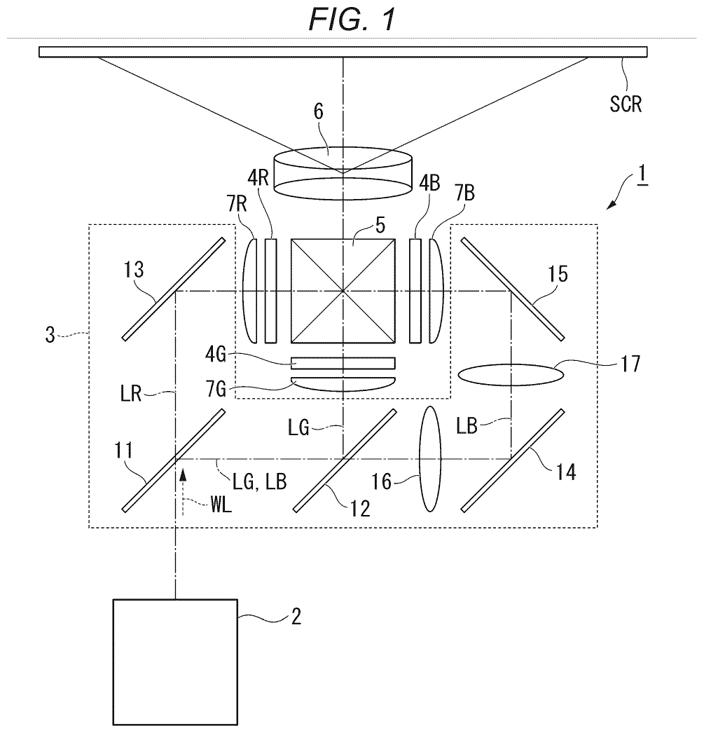

A projector according to a first embodiment of the present disclosure will first be described with reference to FIG. 1. FIG. 1 is a schematic view showing the configuration of a projector 1 according to the first embodiment.

The projector 1 is a projection-type image display apparatus that displays a video on a screen SCR, as shown in FIG. 1. The projector 1 includes a light source apparatus 2, a color separation system 3, light modulators 4R, 4G, and 4B, a light combining system 5, and a projection optical apparatus 6. The projector 1 is a three-panel projector including three light modulators.

The light source apparatus 2 outputs white illumination light WL toward the color separation system 3. The illumination light WL is illumination light in the projector 1, and contains red light LR, green light LG, and blue light LB. The configuration of the light source apparatus 2 will be described later.

The color separation system 3 separates the illumination light WL into the red light LR, the green light LG, and the blue light LB. The color separation system 3 includes, for example, a first dichroic mirror 11, a second dichroic mirror 12, a first total reflection mirror 13, a second total reflection mirror 14, a third total reflection mirror 15, a first relay lens 16, and a second relay lens 17.

The first dichroic mirror 11 is disposed in the optical path of the illumination light WL output from the light source apparatus 2, and separates the incident illumination light WL into the red light LR, and the mixture of the green light LG and the blue light LB. The first dichroic mirror 11 transmits the red light LR and reflects the green light LG and the blue light LB. The second dichroic mirror 12 is disposed in the optical path common to the green light LG and the blue light LB output from the first dichroic mirror 11, and separates the green light LG and the blue light LB from each other. The second dichroic mirror 12 transmits the blue light LB and reflects the green light LG.

The first total reflection mirror 13 reflects the red light LR toward the light modulator 4R. The second total reflection mirror 14 and the third total reflection mirror 15 guide the blue light LB to the light modulator 4B. The green light LG is reflected by the second dichroic mirror 12 toward the light modulator 4G. The red light LR, the green light LG, and the blue light LB contained in the illumination light WL correspond to the light output from the light source apparatus 2.

The first relay lens 16 is disposed in the optical path of the blue light LB between the second dichroic mirror 12 and the second total reflection mirror 14. The second relay lens 17 is disposed in the optical path of the blue light LB between the second total reflection mirror 14 and the third total reflection mirror 15. The aforementioned arrangement of the first relay lens 16 and the second relay lens 17 compensates for optical loss of the blue light LB. The optical loss of the blue light LB is caused by the fact that the optical path length of the blue light LB from the first dichroic mirror 11 to the light modulator 4B is longer than the optical path length of the red light LR from the first dichroic mirror 11 to the light modulator 4R and the optical path length of the green light LG from the first dichroic mirror 11 to the light modulator 4G.

The light modulator 4R is disposed in the optical path of the red light LR reflected by the first total reflection mirror 13 and output from the first total reflection mirror 13. The light modulator 4R modulates the red light LR incident thereon in accordance with image information input from an image input apparatus that is not shown to form red image light and outputs the red image light. The light modulator 4G is disposed in the optical path of the green light LG reflected by the second dichroic mirror 12 and output from the second dichroic mirror 12. The light modulator 4G modulates the green light LG incident thereon in accordance with image information input from the image input apparatus, which is not shown, to form green image light and outputs the green image light. The light modulator 4B is disposed in the optical path of the blue light LB reflected by the third total reflection mirror 15 and output from the third total reflection mirror 15. The light modulator 4B modulates the blue light LB incident thereon in accordance with image information input from the image input apparatus, which is not shown, to form blue image light and outputs the blue image light. The image input apparatus is, for example, a personal computer or a portable terminal device.

The light modulators 4R, 4G, and 4B are each, for example, a transmissive liquid crystal panel. Polarizers that are not shown are disposed at the light incident and exiting sides of each of the liquid crystal panels. A field lens 7R is disposed in the optical path of the red light LR between the first total reflection mirror 13 and the light modulator 4R. A field lens 7G is disposed in the optical path of the green light LG between the second dichroic mirror 12 and the light modulator 4G. A field lens 7B is disposed in the optical path of the blue light LB between the third total reflection mirror 15 and the light modulator 4B.

The light combining system 5 is disposed so as to lie on the optical path of the red image light output from the light modulator 4R, the optical path of the green image light output from the light modulator 4G, and the optical path of the blue image light output from the light modulator 4B. In the plan view as shown in FIG. 1 or a side view, the position where the light combining system 5 combines the three types of color light with each other coincides with the intersection of the optical path of the red image light, the optical path of the green image light, and the optical path of the blue image light. The light combining system 5 combines the red image light, the green image light, and the blue image light with each other to form color image light. The light combining system 5 outputs the color image light. The light combining system 5 is, for example, a cross dichroic prism.

The projection optical apparatus 6 is disposed in the optical path of the color image light output from the light combining system 5. The color image light output from the light combining system 5 corresponds to the light modulated by the light modulators 4R, 4G, and 4B. The projection optical apparatus 6 enlarges the color image light output from the light combining system 5 and entering the projection optical apparatus 6, and projects the enlarged color image light toward the screen SCR. The color image light enlarged and projected by the projection optical apparatus 6 is displayed as a color video on a display surface of the screen SCR that is a surface facing a light exiting surface of the projection optical apparatus 6.

The projection optical apparatus 6 is configured, for example, with multiple optical lenses, and may instead be configured with a single optical lens. Examples of the optical lenses may include a variety of lenses, such as a planoconvex lens, a biconvex lens, a meniscus lens, an aspherical lens, a rod lens, and a freeform surface lens.

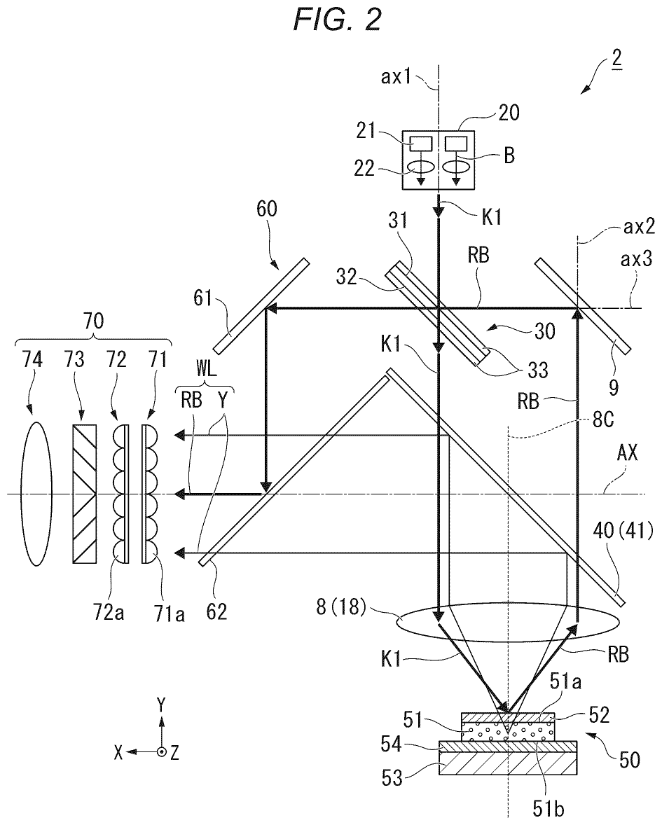

A light source apparatus according to an embodiment of the present disclosure will subsequently be described. FIG. 2 is a schematic view showing the configuration of the light source apparatus 2 according to the present embodiment.

In the following drawings including FIG. 2, each element of the light source apparatus 2 will be described by using an XYZ coordinate system as necessary. The X-axis is an axis parallel to an illumination optical axis AX and an optical axis ax3 of the light source apparatus 2, the Y-axis is an axis parallel to optical axes ax1 and ax2 of the light source apparatus 2, and the Z-axis is an axis orthogonal to the X-axis and the Y-axis. That is, the optical axes ax1, ax2, and ax3 and the illumination optical axis AX are in the same plane, and the optical axes ax1 and ax2 are orthogonal to the illumination optical axis AX and the optical axis ax3.

The light source apparatus 2 includes a light source 20, a diffuser 30, an optical element 40, a wavelength converter 50, an optical path adjustment system 60, a light collection system 8, a reflection system 9, and a uniform illumination system 70, as shown in FIG. 2.

In the light source apparatus 2 according to the present embodiment, the light source 20, the diffuser 30, the optical element 40, the light collection system 8, and the wavelength converter 50 are arranged along the optical axis ax1, which is the optical path of the chief ray of blue light K1 output from the light source 20. The wavelength converter 50, the light collection system 8, the optical element 40, and the reflection system 9 are arranged along the optical axis ax2, which is the optical path of the chief ray of blue reflected light RB, which is output from the wavelength converter 50 and will be described later. The reflection system 9, the diffuser 30, and the optical path adjustment system 60 are arranged along the optical axis ax3, which is the optical path of the chief ray of the blue reflected light RB reflected by the reflection system 9. The optical element 40 and the optical path adjustment system 60 are arranged along the illumination optical axis AX.

The light source 20 includes multiple light emitters 21 and multiple collimation lenses 22. The multiple light emitters 21 are each configured with a semiconductor laser. The multiple light emitters 21 are arranged in an array in an XZ plane perpendicular to the optical axis ax1. The light emitters 21 each emit a blue beam B configured with a light beam having a peak wavelength of, for example, 445 nm. Note that the light emitters 21 can instead each be a semiconductor laser that emits a beam B having a wavelength other than 445 nm (460 nm, for example).

The multiple collimation lenses 22 are arranged, for example, in an array. The multiple collimation lenses 22 are disposed in correspondence with the multiple light emitters 21, respectively. The collimation lenses 22 each convert the beam B emitted from the corresponding light emitter 21 into parallelized light.

The light source 20 thus outputs the blue light K1 in the form of a parallelized luminous flux having a blue wavelength band (first wavelength band) and containing the multiple beams B.

The blue light K1 output from the light source 20 enters the diffuser 30. The diffuser 30 transmits the blue light K1 output from the light source 20. The diffuser 30 is disposed so as to incline at an angle of 45° with respect to the optical axis ax1 of the blue light K1.

The diffuser 30 is a transmissive diffuser plate that diffusively transmits the blue light K1. The diffuser 30 has a light incident surface 31, which faces the light source 20, and a light exiting surface 32, which faces the side opposite the light incident surface 31 and via which the diffused light exits. The diffuser 30 in the present embodiment has antireflection films 33, which cover the light incident surface 31 and the light exiting surface 32. The antireflection films 33 are each configured, for example, with an AR coat, and suppress reflection of light at the interface with an air layer at the light incident surface 31 or the light exiting surface 32. The diffuser 30 therefore allows the blue light K1 to be efficiently incident on the light incident surface 31 and to efficiently exit from the light exiting surface 32. Note that the antireflection films 33 do not need to be disposed at both surfaces of the diffuser 30, and may be disposed at least at the light incident surface 31 on the light incident side of the diffuser 30.

The blue light K1 output from the diffuser 30 enters the optical element 40. The optical element 40 includes a first reflection film 41. The first reflection film 41 is configured with a dichroic mirror that transmits the blue light K1 having the first wavelength band and reflects fluorescence Y, which will be described later.

The blue light K1 passes through the optical element 40, and the blue light K1 having passed through the optical element 40 enters the light collection system 8 disposed between the optical element 40 and the wavelength converter 50. The light collection system 8 includes at least one lens 18 having positive power. The lens 18 having positive power is configured, for example, with a convex lens or a planoconvex lens.

The light collection system 8 has the function of directing the blue light K1 in such a way that the blue light K1 is collected at the wavelength converter 50 and the function of picking up and parallelizing the light output from the wavelength converter 50.

The optical axis ax1 of the blue light K1 passing through the optical element 40 and entering the light collection system 8 is shifted from a center axis 8C of the light collection system 8. In the present embodiment, the optical axis ax1 of the blue light K1 is shifted from the center axis 8C of the light collection system 8 toward the +X side in the XY plane.

The blue light K1 is therefore obliquely incident at the center of the wavelength converter 50 in the XY plane. In the present embodiment, it is preferable that the blue light K1 does not overlap with the center axis 8C of the light collection system 8 but enters only a region of the light collection system 8 that is a region shifted from the center axis 8C of the light collection system 8 toward the +X side. A reflected component of the blue light K1 that is reflected by the wavelength converter 50 can thus be efficiently extracted from a region shifted from the center axis 8C and facing the −X side, so that the reflected component of the blue light K1 can efficiently enter the downstream light collection system 8.

The wavelength converter 50 converts part of the blue light K1 into the fluorescence Y. The wavelength converter 50 includes a wavelength conversion layer 51, a second reflection film 52, a substrate 53, and a reflection member 54.

The wavelength conversion layer 51 contains a ceramic phosphor that converts the blue light K1 having the first wavelength band into the fluorescence Y having a second wavelength band different from the first wavelength band. The second wavelength band ranges, for example, from 490 to 750 nm, and the fluorescence Y is yellow light containing a green light component and a red light component. Note that the phosphor may contain a single crystal phosphor. The blue light K1 in the present embodiment corresponds to an example of the “first light” in the present disclosure, and the fluorescence Y in the present embodiment corresponds to an example of the “second light” in the present disclosure.

The substrate 53 functions as a support substrate that supports the reflection member 54 and the wavelength conversion layer 51, and also functions as a heat dissipation substrate that dissipates heat generated in the wavelength conversion layer 51. The substrate 53 is made of a material having high thermal conductivity, for example, metal or ceramic. The substrate 53 may include, for example, a heat dissipation member such as a heat sink at the surface opposite the surface that supports the wavelength conversion layer 51.

The reflection member 54 is provided between the substrate 53 and the wavelength conversion layer 51, and reflects the fluorescence Y incident from the wavelength conversion layer 51 toward the wavelength conversion layer 51. The reflection member 54 is configured, for example, with a stacked film including a dielectric multilayer film, a metal mirror, a reflection enhancing film, and the like.

The wavelength conversion layer 51 has a first surface 51a and a second surface 51b facing opposite sides. The first surface 51a of the wavelength conversion layer 51 is a light incident surface on which the blue light K1 is incident, and is a surface that functions as a light exiting surface via which the fluorescence Y exits. The second surface 51b of the wavelength conversion layer 51 is a surface facing the substrate 53.

The wavelength conversion layer 51 contains, for example, an yttrium-aluminum-garnet-based (YAG-based) phosphor. Consider YAG: Ce, which contains cerium (Ce) as an activator, by way of example, and the phosphor can be made, for example, of a material produced by mixing raw powder materials containing Y₂O₃, Al₂O₃, CeO₃, and other constituent elements with one another and causing the mixture to undergo a solid-phase reaction; Y—Al—O amorphous particles produced by using a coprecipitation method, a sol-gel method, or any other wet method; or YAG particles produced by using a spray-drying method, a flame-based thermal decomposition method, a thermal plasma method, or any other gas-phase method.

The second reflection film 52 is provided at the first surface 51a of the wavelength conversion layer 51. The first surface 51a of the wavelength conversion layer 51 is substantially planar, and the second reflection film 52 is also configured with a planar film.

The second reflection film 52 is configured with a dielectric multilayer film having an optical characteristic of transmitting the fluorescence Y and part of the blue light K1 and reflecting the other part of the blue light K1. In the present embodiment, when the transmittance of the second reflection film 52 for the blue light K1 is set, for example, at 20%, the second reflection film 52 transmits part (20%) of the blue light K1 and reflects the other part (80%) of the blue light K1 to separate the blue light K1 into the part and the other part.

The part of the blue light K1 having passed through the second reflection film 52 enters the wavelength conversion layer 51 as excitation light and is converted into the fluorescence Y. The fluorescence Y passes through the second reflection film 52 provided at the first surface 51a of the wavelength conversion layer 51 and exits out of the wavelength converter 50. The fluorescence Y exits omnidirectionally over a wide radiation angle substantially around the Y-axis direction in the form of Lambertian light emission. The light collection system 8 in the present embodiment is so disposed that the light emission center of the fluorescence Y coincides with the center axis 8C. The light collection system 8 can therefore efficiently capture the fluorescence Y output over the wide radiation angle in the form of Lambertian light emission.

The fluorescence Y is substantially parallelized by the light collection system 8, and the chief ray of the fluorescence Y travels along the center axis 8C and enters the optical element 40. The fluorescence Y having entered the optical element 40 is reflected by the first reflection film 41, travels along the illumination optical axis AX, and enters the optical path adjustment system 60.

The other part of the blue light K1, which is the part reflected by the second reflection film 52, is output from the wavelength converter 50 toward the light collection system 8 along with the fluorescence Y. The other part of the blue light K1 is blue-component-containing light that forms, along with the yellow fluorescence Y, the white illumination light WL.

In the following description, the other part of the blue light K1, which is the part reflected by the second reflection film 52, is referred to in some cases as the blue reflected light RB. That is, the blue reflected light RB corresponds to an example of “another part of the first light” in the present disclosure.

As described above, in the light source apparatus 2 according to the present embodiment, in which the optical path of the fluorescence Y output from the wavelength converter 50 and entering the optical element 40 coincides with the optical path of the blue reflected light RB reflected by the second reflection film 52 and entering the optical element 40, the light collection system 8 can also be used as an optical system that picks up the fluorescence Y and the blue reflected light RB. According to the configuration described above, in which a portion of the optical path of the light collection system 8 is common to the fluorescence and the blue component for illumination light, the size of the apparatus configuration can be reduced as compared with a configuration in which multiple light collection systems are required, that is, the optical path of the fluorescence and the optical path of the blue component for illumination light are separately provided.

As described above, the blue light K1 obliquely enters the wavelength converter 50 and is specularly reflected by the second reflection film 52. The blue reflected light RB, which is the reflected component of the blue light K1, therefore travels along an optical path different from the optical path of the blue light K1 directed to the wavelength converter 50, and enters the light collection system 8. The blue reflected light RB is parallelized by the light collection system 8, travels along the optical axis ax2, and enters the optical element 40. The blue reflected light RB having the first wavelength band passes through the first reflection film 41 of the optical element 40.

The blue reflected light RB is incident on the reflection system 9. The reflection system 9 is disposed so as to incline at an angle of 45° with respect to the optical axis ax2 of the blue reflected light RB. The reflection system 9 reflects the blue reflected light RB output from the wavelength converter 50 along the optical axis ax3 orthogonal to the optical axis ax2. The chief ray of the blue reflected light RB after reflected by the reflection system 9 thus travels along the optical axis ax3. The blue reflected light RB reflected by the reflection system 9 is incident on the light incident surface 31 of the diffuser 30. That is, the blue reflected light RB, which is the other part of the blue light K1, which is the part separated by the second reflection film 52, enters the diffuser 30 again.

As described above, the diffuser 30 transmits the blue light K1 output from the light source 20 and transmits the blue reflected light RB output from the reflection system 9. That is, the blue reflected light RB is diffused by the diffuser 30 when passing therethrough twice.

The blue light K1 in the present embodiment is laser light, and is therefore highly coherent and tends to cause interference fringes and speckle noise to be visually recognized. In contrast, the blue light K1 is caused to pass through the diffuser 30 twice and is therefore sufficiently diffused in the present embodiment, so that the produced interference fringes can be made hardly noticeable even when the blue light K1, which is laser light, is used.

In the light source apparatus 2 according to the present embodiment, the blue reflected light RB having passed through the diffuser 30 and the fluorescence Y reflected by the optical element 40 are output in the same direction (X-axis direction). That is, the direction in which the blue reflected light RB is reflected by the reflection system 9 and passes through the diffuser 30 extends along the direction in which the fluorescence Y is reflected by the optical element 40. According to the configuration described above, since the blue reflected light RB and the fluorescence Y are output in the same direction, the white illumination light WL containing the blue reflected light RB and the fluorescence Y can be efficiently generated.

The light source apparatus 2 according to the present embodiment further includes the optical path adjustment system 60, which the blue reflected light RB having passed through the diffuser 30 and the fluorescence Y reflected by the optical element 40 enter.

The optical path adjustment system 60 includes a first mirror 61 and a second mirror 62.

The first mirror 61 is disposed so as to incline at an angle of 45° with respect to the optical axis ax3 of the blue reflected light RB having passed through the diffuser 30. The second mirror 62 is disposed on the −Y side of the first mirror 61 and on the +X side of the optical element 40 so as to face the first mirror 61. The second mirror 62 is disposed next to the optical element 40 on the illumination optical axis AX.

The first mirror 61 is configured with a mirror that reflects the blue reflected light RB. The first mirror 61 reflects the blue reflected light RB toward the −Y side. The blue reflected light RB reflected by the first mirror 61 is incident on the second mirror 62. The second mirror 62 is configured with a dichroic mirror having an optical characteristic of reflecting the blue reflected light RB, which is light having the first wavelength band, and transmitting the fluorescence Y, which is light having the second wavelength band.

The configuration in which the blue reflected light RB is reflected by the first mirror 61 and the second mirror 62 causes the optical path of the blue reflected light RB to be shifted toward the −Y side and approaches the illumination optical axis AX after passing through the optical path adjustment system 60. Since the fluorescence Y passes through the second mirror 62, the optical path of the fluorescence Y does not change before and after passing through the optical path adjustment system 60.

The optical path adjustment system 60 brings the optical path of the blue reflected light RB reflected by the reflection system 9 close to the optical path of the fluorescence Y (illumination optical axis AX) reflected by the optical element 40. The optical path adjustment system 60 can therefore achieve a state in which the optical paths of the blue reflected light RB and the fluorescence Y at least partially overlap with each other. The configuration described above, in which the optical paths of the blue reflected light RB and the fluorescence Y overlap with each other, can suppress color unevenness of the illumination light WL.

As described above, in the light source apparatus 2 according to the present embodiment, the optical path adjustment system 60 guides the blue reflected light RB to the optical path of the fluorescence Y to generate the white illumination light WL, and causes the white illumination light WL to enter the uniform illumination system 70. The uniform illumination system 70 is disposed along the illumination optical axis AX of the light source apparatus 2. The uniform illumination system 70 includes a first lens array 71, a second lens array 72, a polarization converter 73, and a superimposing lens 74.

The first lens array 71 includes multiple first lenses 71a, which divide the illumination light WL incident from the optical path adjustment system 60 into multiple sub-luminous fluxes. The multiple first lenses 71a are arranged in a matrix in a plane perpendicular to the illumination optical axis AX.

The second lens array 72 includes multiple second lenses 72a corresponding to the multiple first lenses 71a of the first lens array 71. The multiple second lenses 72a are arranged in a matrix in a plane perpendicular to the illumination optical axis AX.

The second lens array 72 along with the superimposing lens 74 brings images of the first lenses 71a of the first lens array 71 into focus in the vicinity of an image formation region of each of the light modulators 4R, 4G, and 4B.

The polarization converter 73 converts the light output from the second lens array 72 into one kind of linearly polarized light. The polarization converter 73 includes, for example, polarization separation films and retardation films (none of which is shown).

The superimposing lens 74 collects the sub-luminous fluxes output from the polarization converter 73 and superimposes the collected sub-luminous fluxes on one another in the vicinity of the image formation region of each of the light modulators 4R, 4G, and 4B. Note that the uniform illumination system 70 may include a rod lens that homogenizes the illuminance distribution of light.

As described above, the light source apparatus 2 according to the present embodiment includes the light source 20, which outputs the blue light K1 having a blue wavelength band, the diffuser 30, which the blue light K1 output from the light source 20 enters, the optical element 40, which the blue light K1 having passed through the diffuser 30 enters, the light collection system 8, which the blue light K1 having passed through the optical element 40 enters, the wavelength converter 50, which converts part of the blue light K1 into the fluorescence Y having a yellow wavelength band different from the blue wavelength band, and the reflection system 9, which reflects the blue reflected light RB, which is the other part of the blue light K1 output from the wavelength converter 50. The optical element 40 includes the first reflection film 41, which transmits the blue light K1 and reflects the fluorescence Y. The wavelength converter 50 includes the wavelength conversion layer 51 having the first surface 51a, on which the blue light K1 is incident, and the second reflection film 52, which is provided at the first surface 51a and separates the blue light K1 into the excitation light and the blue reflected light RB. The blue reflected light RB separated by the second reflection film 52 enters the diffuser 30.

In the light source apparatus 2 according to the present embodiment, the second reflection film 52 provided at the first surface 51a of the wavelength converter 50 can separate the blue light K1 output from the light source 20 into the excitation light and the blue component of the illumination light. The optical path of the fluorescence Y output from the wavelength converter 50 and the optical path of the blue component reflected by the second reflection film 52 thus partially coincide with each other, so that the size of the apparatus configuration can be reduced.

Furthermore, in the light source apparatus 2 according to the present embodiment, the blue reflected light RB passes through the diffuser 30 twice and is therefore sufficiently diffused. Therefore, even when laser light, which is highly coherent, is used as the blue light K1, the light source apparatus 2 according to the present embodiment can make interference fringes and speckle noise produced in the illumination light WL hardly noticeable. The light source apparatus 2 according to the present embodiment can therefore generate the illumination light WL that prevents interference fringes or speckle noise from being produced.

Note that the uniform illumination system 70 in the light source apparatus 2 according to the present embodiment is not an essential element, and the uniform illumination system 70 may be omitted depending on the illuminance distribution or the like required for the illumination light WL.

The projector 1 according to the present embodiment includes the light source apparatus 2 described above and can therefore be a compact projector that displays a high-quality color image in which interference fringes and speckle noise are suppressed.

### First Modification

A light source apparatus according to a first modification will subsequently be described with reference to the drawings. The present modification is the same as the first embodiment in terms of the basic configuration, but differs therefrom in terms of the layout of the light source with respect to the diffuser. The configurations relating to the difference in the layout will therefore be primarily described below, and the elements common to those in the drawings used in the embodiment described above have the same reference characters and will not be described.

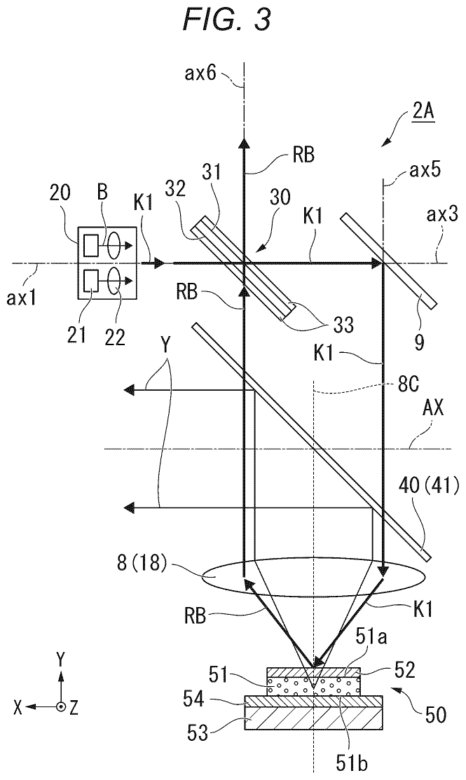

FIG. 3 is a schematic view showing the configuration of a light source apparatus 2A according to the present modification.

The light source apparatus 2A according to the present modification includes the light source 20, the diffuser 30, the optical element 40, the wavelength converter 50, the light collection system 8, and the reflection system 9, as shown in FIG. 3.

In the light source apparatus 2A according to the present modification, the light source 20, the diffuser 30, and the reflection system 9 are arranged along an optical axis ax3, which is the optical path of the chief ray of the blue light K1 output from the light source 20. The reflection system 9, the optical element 40, the light collection system 8, and the wavelength converter 50 are arranged along an optical axis ax5, which is the optical path of the chief ray of the blue light K1 reflected by the reflection system 9. The wavelength converter 50, the light collection system 8, the optical element 40, and the diffuser 30 are arranged along an optical axis ax6, which is the optical path of the chief ray of blue reflected light RB output from the wavelength converter 50.

In the present modification, the light source 20 outputs the blue light K1 from the +X side with respect to the diffuser 30. The blue light K1 passes through the diffuser 30 and is incident on the reflection system 9. The reflection system 9 reflects the blue light K1 having passed through the diffuser 30 and causes the reflected blue light K1 to travel along the optical axis ax5.

The blue light K1 reflected by the reflection system 9 enters the optical element 40. The optical element 40 transmits the blue light K1 having the first wavelength band. The blue light K1 having passed through the optical element 40 enters the light collection system 8.

The optical axis ax1 of the blue light K1 is shifted from the center axis 8C of the light collection system 8. In the present modification, the optical axis ax1 of the blue light K1 is shifted toward the −X side in the XY plane with respect to the center axis 8C of the light collection system 8. The blue light K1 is therefore obliquely incident on a central portion of the wavelength converter 50.

The other part of the blue light K1 is reflected by the second reflection film 52 as the blue reflected light RB, travels along an optical path different from the optical path of the blue light K1, and enters the light collection system 8. The blue reflected light RB is parallelized by the light collection system 8, travels along the optical axis ax6, and passes through the optical element 40 and the diffuser 30.

The fluorescence Y generated by the wavelength converter 50 is substantially parallelized by the light collection system 8, enters the optical element 40, and is reflected by the optical element 40 toward the +X side.

Also in the light source apparatus 2A according to the present modification, the blue reflected light RB, which is the other part of the blue light K1, which is the part separated by the second reflection film 52, enters the diffuser 30 again, so that the blue reflected light RB passes through the diffuser 30 twice and is diffused. Therefore, even when the blue light K1, which is laser light, is used, the produced interference fringes and speckle noise can be made hardly noticeable.

As described above, the light source apparatus 2A according to the present modification includes the light source 20, which outputs the blue light K1 having the blue wavelength band, the diffuser 30, which transmits the blue light K1 output from the light source 20, the reflection system 9, which reflects the blue light K1 having passed through the diffuser 30, the optical element 40, which the blue light K1 reflected by the reflection system 9 enters, the light collection system 8, which the blue light K1 having passed through the optical element 40 enters, and the wavelength converter 50, which converts part of the blue light K1 into the fluorescence Y having the yellow wavelength band different from the blue wavelength band. The optical element 40 includes the first reflection film 41, which transmits the blue light K1 and reflects the fluorescence Y. The wavelength converter 50 includes the wavelength conversion layer 51 having the first surface 51a, on which the blue light K1 is incident, and the second reflection film 52, which is provided at the first surface 51a and separates the blue light K1 into the excitation light and the blue reflected light RB. The blue reflected light RB separated by the second reflection film 52 enters the diffuser 30.

In the light source apparatus 2A according to the present modification, the second reflection film 52 provided at the first surface 51a of the wavelength converter 50 can separate the blue light K1 output from the light source 20 into the excitation light and the blue component of the illumination light. The optical path of the fluorescence Y output from the wavelength converter 50 and the optical path of the blue component reflected by the second reflection film 52 thus partially coincide with each other, so that the size of the apparatus configuration can be reduced.

Note in the light source apparatus 2A according to the present modification that the direction in which the fluorescence Y exits (X-axis direction) differs from the direction in which the blue reflected light RB exits (Y-axis direction), but the fluorescence Y and the blue reflected light RB may exit in the same direction by using a configuration in which a reflection member such as a mirror is disposed in the optical path of either the fluorescence Y or the blue reflected light RB. Furthermore, the uniform illumination system 70 may be disposed, as in the light source apparatus 2 according to the first embodiment.

### Second Modification

A light source apparatus according to a second modification will subsequently be described with reference to the drawings. The present modification is the same as the first embodiment in terms of the basic configuration, but differs therefrom in terms of the configuration of the diffuser. The configurations relating to the difference in the diffuser will therefore be primarily described below, and the elements common to those in the drawings used in the embodiment described above have the same reference characters and will not be described.

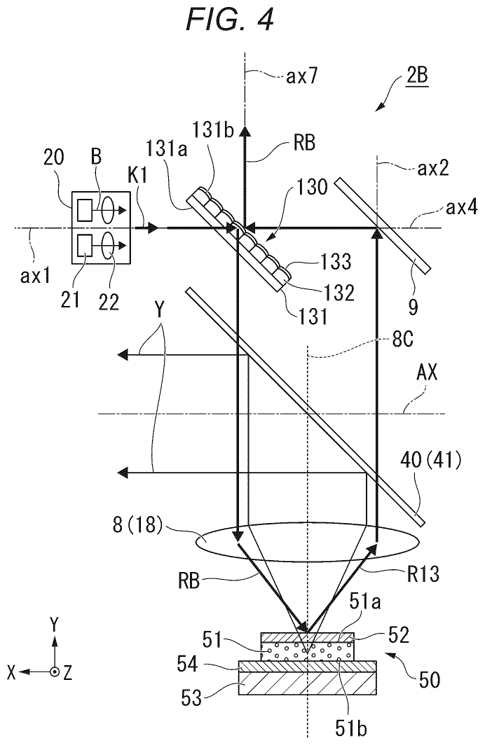

FIG. 4 is a schematic view showing the configuration of a light source apparatus 2B according to the present modification.

The light source apparatus 2B according to the present modification includes the light source 20, a diffuser 130, the optical element 40, the wavelength converter 50, the light collection system 8, and the reflection system 9, as shown in FIG. 4.

In the light source apparatus 2B according to the present modification, the light source 20, the diffuser 30, and the reflection system 9 are arranged along the optical axis ax4, which is the optical path of the chief ray of the blue light K1 output from the light source 20. The diffuser 130, the optical element 40, the light collection system 8, and the wavelength converter 50 are arranged along an optical axis ax7, which is the optical path of the chief ray of the blue light K1 reflected by the diffuser 130. The wavelength converter 50, the light collection system 8, the optical element 40, and the reflection system 9 are arranged along the optical axis ax2, which is the optical path of the chief ray of the blue reflected light RB output from the wavelength converter 50. The reflection system 9, the diffuser 130, and the light source 20 are arranged along the optical axis ax4, which is the optical path of the chief ray of the blue reflected light RB reflected by the reflection system 9.

In the present modification, the diffuser 130 is a reflective diffuser plate that diffusively reflects the blue light K1. The diffuser 130 includes a base 131 and a reflection layer 133. The base 131 is configured with a light transmissive substrate made, for example, with glass or plastic, and has a planar surface 131a and a diffusion surface 131b, which faces the side opposite the planar surface 131a and includes an uneven structure 132 configured with multiple protrusions and recesses. The reflection layer 133 is configured, for example, with a metal film or a dielectric multilayer film, and covers the surface of the uneven structure 132 of the base 131. The diffusion surface 131b in the present modification corresponds to the “one surface of the base” in the present disclosure.

The blue light K1 output from the light source 20 in incident on the diffusion surface 131b from the planar surface 131a of the base 131 of the diffuser 130. The blue light K1 incident on the diffusion surface 131b is diffused by the diffusion surface 131b, reflected by the reflection layer 133, and output from the diffuser 130 toward the −Y side. The chief ray of the blue light K1 diffusively reflected by the diffuser 130 travels along the optical axis ax7 and enters the optical element 40.

The blue light K1 passes through the optical element 40 and enters the light collection system 8. The optical axis ax7 of the blue light K1 is shifted from the center axis 8C of the light collection system 8. In the present modification, the optical axis ax7 of the blue light K1 is shifted toward the +X side in the XY plane with respect to the center axis 8C of the light collection system 8, so that the blue light K1 is obliquely incident on a central portion of the wavelength converter 50.

The other part of the blue light K1 is reflected by the second reflection film 52 as the blue reflected light RB, parallelized by the light collection system 8, travels along the optical axis ax2, passes through the optical element 40, and is incident on the reflection system 9. The blue reflected light RB is reflected by the reflection system 9 along the optical axis ax4 and is incident on the diffuser 130 from the −X side.

The blue reflected light RB is incident on the diffusion surface 131b of the diffuser 130. The blue reflected light RB incident on the diffuser 130 is diffused at the diffusion surface 131b and reflected by the reflection layer 133, which covers the diffusion surface 131b. The blue reflected light RB is thus output from the diffuser 130 toward the +Y side.

The fluorescence Y generated by the wavelength converter 50 is substantially parallelized by the light collection system 8, enters the optical element 40, and is reflected by the optical element 40 toward the +X side.

Also in the light source apparatus 2B according to the present modification, the blue reflected light RB, which is the other part of the blue light K1, which is the part separated by the second reflection film 52, enters the diffuser 130 again, so that the blue reflected light RB passes through the diffuser 130 twice and is diffused. Therefore, even when the blue light K1, which is laser light, is used, the produced interference fringes and speckle noise can be made hardly noticeable.

As described above, in the light source apparatus 2B according to the present modification, even when the optically reflective diffuser 130 is used, the second reflection film 52 provided at the first surface 51a of the wavelength converter 50 can separate the blue light K1 output from the light source 20 into the excitation light and the blue component of the illumination light. The optical path of the fluorescence Y output from the wavelength converter 50 and the optical path of the blue component reflected by the second reflection film 52 thus partially coincide with each other, so that the size of the apparatus configuration can be reduced.

Note in the light source apparatus 2B according to the present modification that the direction in which the fluorescence Y exits (X-axis direction) differs from the direction in which the blue reflected light RB exits (Y-axis direction), but the fluorescence Y and the blue reflected light RB may exit in the same direction by using a configuration in which a reflection member such as a mirror is disposed in the optical path of either the fluorescence Y or the blue reflected light RB. Furthermore, the uniform illumination system 70 may be disposed, as in the light source apparatus 2 according to the first embodiment.

Furthermore, the diffuser 130 in the present modification has been presented with reference to the case where one side of the base 131 is the diffusion surface 131b, but the diffuser may be provided with uneven structures on both surfaces of the base and therefore having diffusion surfaces on both sides.

### Second Embodiment

A light source apparatus according to a second embodiment of the present disclosure will subsequently be described. The second embodiment is the same as the first embodiment in terms of the basic configuration, but differs therefrom in terms of the configurations of the optical element and the reflection system. The configurations of the optical element and the reflection system will therefore be primarily described below, and the elements common to those in the drawings used in the embodiment described above have the same reference characters and will not be described.

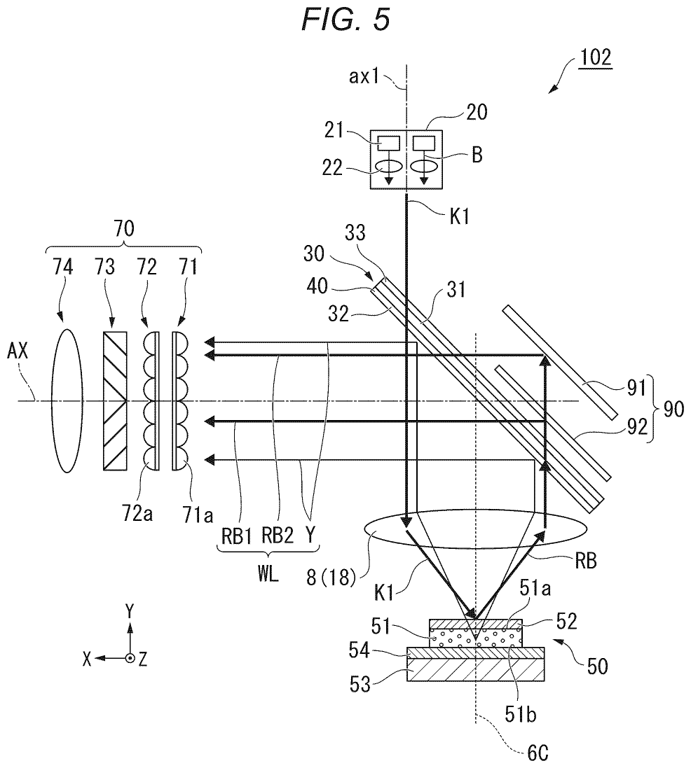

FIG. 5 is a schematic view showing the configuration of a light source apparatus 102 according to the second embodiment.

The light source apparatus 102 according to the present embodiment includes the light source 20, the diffuser 30, the optical element 40, the wavelength converter 50, the light collection system 8, a reflection system 90, and the uniform illumination system 70, as shown in FIG. 5.

In the light source apparatus 102 according to the present embodiment, the optical element 40 is provided in the diffuser 30. Specifically, the optical element 40 is provided at the light exiting surface 32 of the diffuser 30. The diffuser 30 in the present embodiment has an antireflection film 33, which covers the light incident surface 31.

The reflection system 90 includes a first reflector 91 and a second reflector 92 disposed between the first reflector 91 and the optical element 40. The first reflector 91 and the second reflector 92 are disposed so as to face each other with a gap therebetween, and are disposed so as to incline at an angle of 45° with respect to the optical axis ax2 of the blue reflected light RB.

The first reflector 91 is, for example, a mirror configured with a metal film or a dielectric multilayer film, and reflects light incident thereon. The second reflector 92 is a semi-transmissive, semi reflective mirror that reflects part of incident light and transmits the remainder. The second reflector 92 in the present embodiment is configured with what is called a half-silvered mirror that transmits half of the incident light and reflects the remainder.

In the light source apparatus 102 according to the present embodiment, the fluorescence Y output from the wavelength converter 50 is reflected by the optical element 40 and travels along the illumination optical axis AX.

The blue reflected light RB output from the wavelength converter 50 passes through the optical element 40 and the diffuser 30 and is incident on the second reflector 92.

First blue reflected light RB1, which is part of the blue reflected light RB, is reflected by the second reflector 92 toward the +X side and enters the diffuser 30 again. Second blue reflected light RB2, which is the remainder of the blue reflected light RB, passes through the second reflector 92, is reflected by the first reflector 91 toward the +X side, and enters the diffuser 30 again.

The blue reflected light RB passes the diffuser 30 once and is then incident on the reflection system 90, and first blue reflected light RB1 and the second blue reflected light RB2, into which the blue reflected light RB is separated by the reflection system 90, pass through the diffuser 30 again. As described above, in the light source apparatus 102 according to the present embodiment, the blue reflected light RB enters the diffuser 30 before and after being incident on the reflection system 90.

In the light source apparatus 102 according to the present embodiment, since the blue reflected light RB, which is the reflected component of the blue light K1 having passed through the diffuser 30, passes through the diffuser 30 three times and is therefore diffused by a greater degree, so that interference fringes and speckle noise produced in the illumination light WL can be made hardly noticeable.

The second blue reflected light RB2 reflected by the first reflector 91 passes through the diffuser 30 and the optical element 40 and travels along the illumination optical axis AX. The optical path of the second blue reflected light RB2 overlaps with at least part of the optical path of the fluorescence Y reflected by the optical element 40.

The first blue reflected light RB1 reflected by the second reflector 92 passes through the diffuser 30 and the optical element 40 and travels along the illumination optical axis AX. The optical path of the first blue reflected light RB1 overlaps with at least part of the optical path of the fluorescence Y reflected by the optical element 40.

As described above, the light source apparatus 102 according to the present embodiment allows the optical paths of the first blue reflected light RB1 and the second blue reflected light RB2, into which the blue reflected light RB is separated by the reflection system 90 in the direction perpendicular to the illumination optical axis AX, that is, the luminous flux width direction of the fluorescence Y, to overlap with the optical path of the fluorescence Y. The apparent luminous flux width of the blue reflected light RB is thus made close to the luminous flux width of the fluorescence Y, and the difference in the luminous flux width between the blue reflected light RB and the fluorescence Y contained in the illumination light WL is therefore reduced, so that the color unevenness of the illumination light WL can be suppressed.

### Third Modification

A light source apparatus according to a third modification will subsequently be described with reference to the drawings. The present modification is the same as the second embodiment in terms of the basic configuration, but differs therefrom in terms of the layout of the reflection system. The configurations of the reflection system will therefore be primarily described below, and the elements common to those in the drawings used in the embodiments described above have the same reference characters and will not be described.

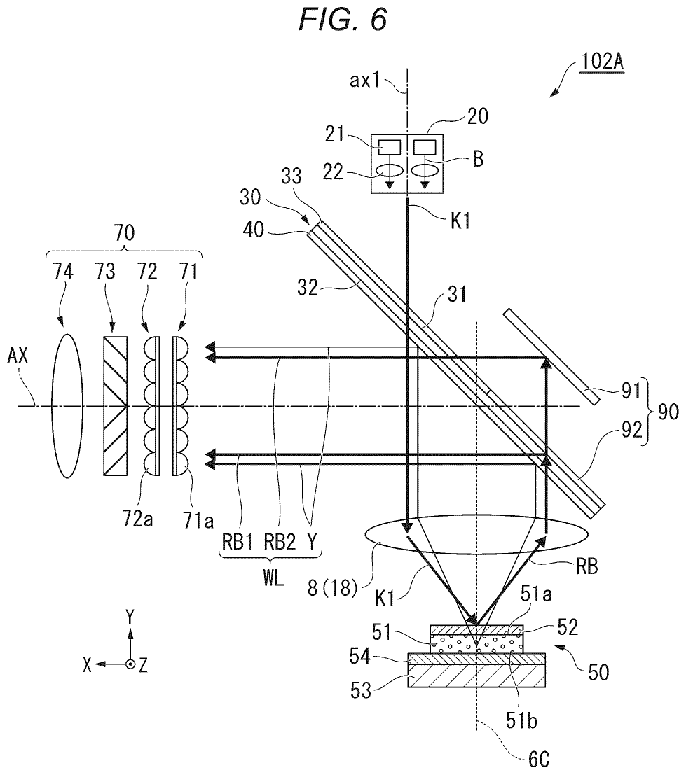

FIG. 6 is a schematic view showing the configuration of a light source apparatus 102A according to the present modification.

In the light source apparatus 102A according to the present modification, the second reflector 92 of the reflection system 90 is provided in the diffuser 30, as shown in FIG. 6. Specifically, the second reflector 92 is provided at a portion of the light incident surface 31 of the diffuser 30. The second reflector 92 is provided at least in a region on which the blue reflected light RB output from the wavelength converter 50 is incident. The light incident surface 31 has the antireflection film 33 in a region other than the region where the second reflector 92 is disposed. That is, the diffuser 30 in the present modification includes the antireflection film 33 and the second reflector 92 at the light incident surface 31.

In the light source apparatus 102A according to the present modification, since the light incident surface 31 of the diffuser 30 can be used as a support member that supports the second reflector 92, a separate support member that supports the second reflector 92 can be omitted.

Note that the technical scope of the present disclosure is not limited to the embodiments described above, and various modifications can be made thereto to the extent that the modifications do not depart from the intent of the present disclosure.

In addition, the specific description of the shapes, the quantity, the arrangements, the materials, and other factors of the elements of the light source apparatus and the projector are not limited to those in the embodiments described above, and can be changed as appropriate.

The present disclosure is summarized below as additional remarks.

### Additional Remark 1

A light source apparatus including:
a light source configured to output first light having a first wavelength band;
a diffuser that the first light output from the light source enters;
an optical element that the first light passing through the diffuser enters;
a light collection system that the first light passing through the optical element enters;
a wavelength converter configured to convert part of the first light into second light having a second wavelength band different from the first wavelength band; and
a reflection system configured to reflect another part of the first light output from the wavelength converter,
wherein the optical element includes a first reflection film configured to transmit the first light and reflect the second light,
the wavelength converter includes a wavelength conversion layer having a first surface on which the first light is incident, and a second reflection film provided at the first surface and configured to separate the first light into the part and the other part, and
the other part of the first light separated by the second reflection film enters the diffuser.

According to the light source apparatus having the configuration described above, the second reflection film provided at the first surface of the wavelength converter can separate the first light output from the light source into part of the first light for wavelength conversion and the other part of the first light for illumination. The optical path of the second light output from the wavelength converter and the optical path of the illumination light reflected by the second reflection film thus coincide with each other, so that the size of the apparatus configuration can be reduced.

Furthermore, the other part of the first light for illumination passes through the diffuser twice and is therefore sufficiently diffused. Therefore, for example, even when laser light, which is highly coherent, is used as the first light, interference fringes and speckle noise produced in the illumination light can be made hardly noticeable. A light source apparatus that generates illumination light that prevents interference fringes or speckle noise from being produced can therefore be provided.

### Additional Remark 2

The light source apparatus according to Additional Remark 1, wherein
the light collection system includes a lens having positive power, and
an optical axis of the first light that passes through the optical element and enters the light collection system is shifted from a center axis of the light collection system.

According to the configuration described above, the first light is obliquely incident on a central portion of the wavelength converter. The other part of the first light is therefore reflected by the second reflection film, travels along an optical path different from the optical path of the first light, and can enter the light collection system.

### Additional Remark 3

The light source apparatus according to Additional Remark 1 or 2, wherein
the diffuser is configured to transmit the first light output from the light source and transmit the other part of the first light output from the reflection system.

According to the configuration described above, a light source apparatus a compact apparatus configuration can be provided when a transmissive diffuser is used.

### Additional Remark 4

The light source apparatus according to Additional Remark 1 or 2, wherein
the diffuser is configured with a light transmissive diffuser, and includes an antireflection film provided at least on a light incident side on which the first light is incident.

The light source apparatus according to Additional Remark 1 or 2, wherein

The configuration described above suppresses reflection of the light at the interface between the light incident surface and an air layer. The diffuser therefore allows the first light to be efficiently incident on the light incident surface.

### Additional Remark 5

The light source apparatus according to Additional Remark 1, wherein
a direction in which the other part of the first light is reflected by the reflection system and passes through the diffuser extends along a direction in which the second light is reflected by the optical element.

According to the configuration described above, since the other part of the first light and the second light are output in the same direction, the illumination light containing the first light and the second light can be efficiently generated.

### Additional Remark 6

The light source apparatus according to Additional Remark 5, further including
an optical path adjustment system configured to bring an optical path of the other part of the first light reflected by the reflection system close to an optical path of the second light reflected by the optical element.

According to the configuration described above, the optical path adjustment system allows the optical path of the other part of the first light to overlap with at least part of the optical path of the second light. The configuration in which the optical path of the other part of the first light overlaps with the optical path of the second light can therefore suppress color unevenness of the illumination light.

### Additional Remark 7

The light source apparatus according to Additional Remark 1 or 2, wherein
the diffuser includes a light transmissive base having an uneven structure provided at one surface of the base, and a reflection layer configured to cover the uneven structure of the base.

The configuration described above can provide a light reflective diffuser in which light incident via one surface of the base is reflected by the reflection layer while being diffused by the uneven structure, and in which light incident via the other surface of the base is diffusively reflected by the reflection layer, which covers the uneven structure. A light source apparatus having a compact apparatus configuration can therefore also be provided even when a light reflective diffuser is used.
can

### Additional Remark 8

The light source apparatus according to any one of Additional Remarks 1 to 6, wherein
the optical element is provided in the diffuser,
the reflection system includes a first reflector configured to reflect incident light, and a second reflector disposed between the first reflector and the optical element and configured to reflect part of the incident light and transmit a remainder of the incident light,
an optical path of the light reflected by the first reflector overlaps with at least a portion of an optical path of the second light reflected by the optical element, and
an optical path of the light reflected by the second reflector overlaps with at least a portion of the optical path of the second light reflected by the optical element.

The configuration described above allows the reflection system to separate the other part of the first light into two in the luminous flux width direction of the second light, and the optical paths of the two types of separated light to overlap with the optical path of the second light. The apparent luminous flux width of the other part of the first light is thus made close to the luminous flux width of the second light, and the difference in the luminous flux width between the other part of the first light and the second light contained in the illumination light is therefore reduced, so that the color unevenness of the illumination light can be suppressed.

### Additional Remark 9

The light source apparatus according to Additional Remark 8, wherein
the other part of the first light enters the diffuser before and after being incident on the reflection system.

According to the configuration described above, since the other part of the first light, which is the reflected component of the first light having passed through the diffuser, passes through the diffuser three times, the light is diffused by a greater degree. Interference fringes and speckle noise produced in the illumination light can therefore be made hardly noticeable.

### Additional Remark 10

The light source apparatus according to Additional Remark 8 or 9, wherein
the second reflector is provided in the diffuser.

According to the configuration described above, since the diffuser can be used as a support member that supports the second reflector, a separate member that supports the second reflector can be omitted.

### Additional Remark 11

A light source apparatus including:
a light source configured to output first light having a first wavelength band;
a diffuser configured to transmit the first light output from the light source;
a reflection system configured to reflect the first light passing through the diffuser;
an optical element that the first light reflected by the reflection system enters;
a light collection system that the first light passing through the optical element enters; and
a wavelength converter configured to convert part of the first light into second light having a second wavelength band different from the first wavelength band,
wherein the optical element includes a first reflection film configured to transmit the first light and reflect the second light,
the wavelength converter includes a wavelength conversion layer having a first surface on which the first light is incident, and a second reflection film provided at the first surface and configured to separate the first light into the part and another part, and
the other part of the first light separated by the second reflection film enters the diffuser.

According to the configuration described above, the second reflection film provided at the first surface of the wavelength converter can separate the first light output from the light source into part of the first light for wavelength conversion and the other part of the first light for illumination. The optical path of the second light output from the wavelength converter and the optical path of the illumination light reflected by the second reflection film thus coincide with each other, so that the size of the apparatus configuration can be reduced.

Furthermore, the other part of the first light for illumination passes through the diffuser twice and is therefore sufficiently diffused. Therefore, for example, even when laser light, which is highly coherent, is used as the first light, interference fringes and speckle noise produced in the illumination light can be made hardly noticeable. A light source apparatus that generates illumination light that prevents interference fringes or speckle noise from being produced can therefore be provided.

### Additional Remark 12

The light source apparatus according to any one of Additional Remarks 1 to 11, wherein
the wavelength converter further includes a substrate configured to support a second surface of the wavelength conversion layer that is a surface opposite the first surface, and a reflection member provided between the substrate and the second surface the wavelength conversion layer and configured to reflect the second light.

According to the configuration described above, the reflection member can reflect the second light toward the wavelength conversion layer. The second light can therefore be efficiently extracted from the wavelength converter.

### Additional Remark 13

A projector including:
the light source apparatus according to any one of Additional Remarks 1 to 12;
a light modulator configured to modulate light incident from the light source apparatus; and
a projection optical apparatus configured to project the light modulated by the light modulator.

Since the projector having the configuration described above includes the light source apparatus described above, a compact projector that displays a high-quality color image in which interference fringes and speckle noise are suppressed can be realized.

What is claimed is:

1. A light source apparatus comprising:
a light source configured to output first light having a first wavelength band;
a diffuser that the first light output from the light source enters;
an optical element that the first t light passing through the diffuser enters;
a light collection system that the first light passing through the optical element enters;
a wavelength converter configured to convert part of the first light into second light having a second wavelength band different from the first wavelength band; and
a reflection system configured to reflect another part of the first light output from the wavelength converter,
wherein the optical element includes a first reflection film configured to transmit the first light and reflect the second light,
the wavelength converter includes a wavelength conversion layer having a first surface on which the first light is incident, and a second reflection film provided at the first surface and configured to separate the first light into the part and the other part, and
the other part of the first light separated by the second reflection film enters the diffuser.

2. The light source apparatus according to claim 1, wherein
the light collection system includes a lens having positive power, and
an optical axis of the first light that passes through the optical element and enters the light collection system is shifted from a center axis of the light collection system.

3. The light source apparatus according to claim 1, wherein
the diffuser is configured to transmit the first light output from the light source and transmit the other part of the first light output from the reflection system.

4. The light source apparatus according to claim 1, wherein
the diffuser is configured with a light transmissive diffuser, and includes an antireflection film provided at least on a light incident side on which the first light is incident.

5. The light source apparatus according to claim 1, wherein
a direction in which the other part of the first light is reflected by the reflection system and passes through the diffuser extends along a direction in which the second light is reflected by the optical element.

6. The light source apparatus according to claim 5, further comprising
an optical path adjustment system configured to bring an optical path of the other part of the first light reflected by the reflection system close to an optical path of the second light reflected by the optical element.

7. The light source apparatus according to claim 1, wherein
the diffuser includes a light transmissive base having an uneven structure provided at one surface of the base, and a reflection layer configured to cover the uneven structure of the base.

8. The light source apparatus according to claim 1, wherein
the optical element is provided in the diffuser,
the reflection system includes a first reflector configured to reflect incident light, and a second reflector disposed between the first reflector and the optical element and configured to reflect part of the incident light and transmit a remainder of the incident light,
an optical path of the light reflected by the first reflector overlaps with at least a portion of an optical path of the second light reflected by the optical element, and
an optical path of the light reflected by the second reflector overlaps with at least a portion of the optical path of the second light reflected by the optical element.

9. The light source apparatus according to claim 8, wherein
the other part of the first light enters the diffuser before and after being incident on the reflection system.

10. The light source apparatus according to claim 8, wherein
the second reflector is provided in the diffuser.

11. A light source apparatus comprising:
a light source configured to output first light having a first wavelength band;
a diffuser configured to transmit the first light output from the light source;
a reflection system configured to reflect the first light passing through the diffuser;
an optical element that the first light reflected by the reflection system enters;
a light collection system that the first light passing through the optical element enters; and
a wavelength converter configured to convert part of the first light into second light having a second wavelength band different from the first wavelength band,
wherein the optical element includes a first reflection film configured to transmit the first light and reflect the second light,
the wavelength converter includes a wavelength conversion layer having a first surface on which the first light is incident, and a second reflection film provided at the first surface and configured to separate the first light into the part and another part, and
the other part of the first light separated by the second reflection film enters the diffuser.

12. The light source apparatus according to claim 1, wherein
the wavelength converter further includes a substrate configured to support a second surface of the wavelength conversion layer that is a surface opposite the first surface, and a reflection member provided between the substrate and the second surface of the wavelength conversion layer and configured to reflect the second light.

13. A projector comprising:
the light source apparatus according to claim 1;
a light modulator configured to modulate light incident from the light source apparatus; and
a projection optical apparatus configured to project the light modulated by the light modulator.
